(19) United States
(12) Patent Application Publication
(10) Pub. No.: US 2004/0214543 A1
(43) Pub. Date: Oct. 28, 2004

(54) Variable capacitor system, microswitch and transmitter-receiver

(76) Inventors: Yasuo Osone, Chiyoda (JP); Noriyo Nishijima, Chiyoda (JP); Norio Nakazato, Kashiwa (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/780,585

(22) Filed: Feb. 19, 2004

(30) Foreign Application Priority Data
Apr. 28, 2003 (JP) 2003-123124
Apr. 28, 2003 (JP) 2003-123120

(51) Int. Cl. H04B 1/26

(52) U.S. Cl. 455/197.2

(57) ABSTRACT

A microelectronic device includes a substrate, a variable capacitor including a driving mechanism for varying capacitance stored by a pair of electrodes formed in a main surface of the substrate, a plurality of fixed capacitors having fixed capacitance stored by a plurality of pairs of electrodes formed in an opposite side of the main surface, wiring for electrically connecting the variable capacitor and the fixed capacitors, and switches disposed in the main surface of the substrate to electrically connect the variable capacitor and a capacitor or capacitors selected from the plurality of fixed capacitors.

### BACKGROUND OF THE INVENTION

The present invention relates to an electronic device such as, for example, capacitor, switch and transmitter-receiver, using the micromachining technique.

In the radio communication field using the millimeter wave or the like which is expected to be utilized in the portable telephone systems on and after the 2.5th generation, the radio local area networks (LAN) prescribed by IEEE 802.11x, the high-degree traffic information system or the like, it is expected to form the so-called ubiquitous network which can make information communication anytime and everywhere without interruption as the near-future technique.

In order to process signals having a plurality of frequency bands in a single terminal, the terminal generally uses a package provided with a plurality of RF circuits for transmitting and receiving the signals having different frequency bands. However, since this method requires the RF circuit for each frequency band, the mounting area occupied by the circuit is made very larger and it is difficult to cope with the request to reduce the mounting area of the RF circuits in the terminal in which the number of semiconductor devices and the functions are increased due to transmission and reception of information of still picture or moving picture even in the signal processing for one frequency band.

Further, the so-called providers such as portable telephone companies are required to develop a high-performance filter circuit due to increased traffic in the radio communication in order to effectively utilize the licensed frequency band in the limited range.

In such a background, switches using the micromachining technique and filters using variable capacitors are being developed instead of conventional switches using semiconductor devices and so-called variable capacitors. These are called the micro-electromechanical system (MEMS) capacitors and expected to make it possible to provide variable capacitors having the wide variable capacitance area and the high Q value (expressing the loss of a dielectric and the higher the Q value is the smaller the loss is) which is the reciprocal of the dielectric tangent (tan δ).

As described above, in the specification, the MEMS-structured device is a structural body having three-dimensional structure manufactured by the so-called semiconductor manufacturing process and is a device served in the application in which electrical signals are treated.

Such variable capacitors using the MEMS technique are disclosed in JP-A-2000-100659 and collected papers of MWE 2001 (K. Ohwada, MEMS Variable Capacitor for RF Application MWE2001 Microwave Workshop Digest, pp. 41-46), for example. Further, the technique including the variable capacitor for the system for varying capacitance by switching a plurality of capacitors by means of MEMS switch is disclosed in JP-A-10-308603.

The structure having the MEMS structure and semiconductor elements such as CMOS (Complementary Metal Oxide Semiconductor) mounted in mixed manner is disclosed in JP-A-9-162462 and a literature cited of Aleksander Dec (Aleksander Dec, Ken Suyama, IEEE Transaction on Microwave Theory and Techniques, Vol. 46, No. 12, December 1998, pp. 2587-2596), for example.

### BRIEF SUMMARY OF THE INVENTION

In the prior-art technique disclosed in JP-A-2000-100659 and the collected papers of MWE 2001 (K. Ohwada, MEMS Variable Capacitor for RF Application MWE2001 Microwave Workshop Digest, pp. 41-46), a plurality of capacitors and switches, for example, are provided and accordingly there is a problem that an area occupied by a circuit therefor is increased. When a module having such a circuit is used in, for example, a portable terminal, it is desired that the high-performance circuit is made smaller.

Further, In the prior-art technique disclosed in JP-A-9-162462 and the literature cited of Aleksander Dec and Ken Suyama in IEEE Transaction on Microwave Theory and Techniques, Vol. 46, No. 12, December 1998, pp. 2587-2596, a switch and a variable capacitor have the structure for achieving a predetermined function by making mechanical operation by electrical signals and realize the predetermined function by deforming a beam structure member mechanically. On the other hand, the inventors have discovered that there is the possibility that when the environmental temperature in operation is changed, the temperature dependency of mechanical and physical property such as rigidity of a constituent member sometimes becomes a problem in order to ensure the function thereof. However, the prior arts do not take the change in the environmental temperature in operation into consideration.

For example, if a portion of a cantilever beam is structured by one kind of material, the rigidity thereof is generally increased when a temperature is lowered. Accordingly, when an operating temperature is high, a switch is turned on even by weak electrostatic suction force. When the operating temperature is low, there is the possibility that the switch cannot be turned on unless strong electrostatic suction force is applied.

Components and devices mounted in so-called portable information terminals such as portable telephones and PDAs (Personal Digital Assistants) having MEMS devices are required to guarantee a wide operating environmental temperature (e.g. −30° C. to 100° C.). In other words, the components and devices are required to have the stable characteristic in a wide temperature range from the outdoors in a high-latitude place in a severe winter to the upper portion of a console panel of an automobile in the middle of summer.

Accordingly, it is an object of the present invention to provide an electronic device using the micromachining technique to solve at least one of the above problems.

The problems can be solved by a MEMS electronic device having the following aspects.

More particularly, there is provided a compact variable capacitor system which can be controlled to have various capacitance, for example.

Alternatively, there is provided a high-performance microswitch and transmitter-receiver which can function even in a wide operating environmental temperature.

Examples of concrete aspects are now described below.

One of the above problems can be solved by forming fixed capacitors on the back side of a substrate and a variable capacitor and switches on the surface of the substrate.

(1) The following aspects can be provided, for example.

A variable capacitor system comprises a substrate, a variable capacitor including a driving mechanism for varying capacitance stored by a pair of electrodes formed in a main surface of the substrate, a plurality of fixed capacitors having fixed capacitance stored by a plurality of pairs of electrodes formed in an opposite side of the main surface, wiring means for electrically connecting the variable capacitor and the fixed capacitors, and a switch disposed in the main surface of the substrate to electrically connect the variable capacitor and a capacitor or capacitors selected from the plurality of fixed capacitors.

(2) In the item (1), the variable capacitor includes first and second electrode layers formed on the main surface of the substrate with space therebetween and a driving mechanism for controlling the space between the first and second electrode layers, and the switch includes first and second wiring layers formed on the main surface of the substrate with space therebetween, a beam supported to the substrate and having a conductive junction, and a driving mechanism for bring the junction into electrical contact with the first or second wiring layer.

(3) In the item (1), the variable capacitor and the fixed capacitors are formed electrically in parallel, total capacitance of the fixed capacitors is larger than maximum capacitance of the variable capacitor, and the switch controls the number of the fixed capacitors connected electrically.

(4) In the item (1), an interval of total fixed capacitance varied when the total capacitance of the fixed capacitors connected electrically by the switch is varied is smaller than a variable capacitance range of the variable capacitor.

(5) In the item (1), an interval of total fixed capacitance varied when the total capacitance of the fixed capacitors connected electrically by the switch is varied is larger than a variable capacitance range of the variable capacitor.

According to the above aspects, the compact variable capacitor system which can be controlled to have various capacitance can be provided. Further, a MEMS capacitor having the satisfactory high-frequency characteristic can be structured. Since elements (three-dimensional structure) having a movable portion are formed on the same side, manufacturing is easy and can be made effectively. An area for the fixed capacitor can be ensured sufficiently and the fixed capacitor having a large area can be formed. Further, since the fixed capacitor having the large area and the switches are connected by means of through-wiring, the total wiring length can be shortened, so that influence by parasitic components in an equivalent circuit can be reduced to improve the characteristics.

Another of the above problems can be solved by provision of a temperature control function disposed in the vicinity of a MEMS device in a transmitter-receiver having the MEMS device and for keeping the operating temperature within a predetermined range.

Consequently, a high-performance transmitter-receiver which can function even in wide operating temperature can be provided. The whole of the apparatus can be made small. Concretely, the following aspect can be provided.

(6) A microswitch comprises a substrate, first and second wiring layers formed on the substrate with space therebetween, a beam supported to the substrate and having a conductive junction, a driving mechanism for bring the junction into electrical contact with the first or second wiring layer, and a temperature control mechanism for controlling temperature of the beam.

(7) A transmitter-receiver comprises a plurality of antennas provided in corresponding manner to frequencies, an antenna changing-over switch for changing over the antenna, an amplifier supplied with a signal received by the antenna through the antenna changing-over switch, a control IC supplied with a signal produced by the amplifier and for producing an output signal, and a temperature control mechanism for controlling temperature of the antenna changing-over switch. The antenna changing-over switch includes a substrate, first and second wiring layers formed on the substrate with space therebetween, and a beam supported to the substrate and having an electrode brought into electrical contact with the first or second wiring layer.

(8) Alternatively, in the receiver, at least the antenna switch or the filter is disposed in a first substrate and the control IC is disposed in a second substrate. Preferably, in the item (7), the temperature control mechanism is disposed in the first substrate. It is preferable in simplification of the structure that the same temperature control mechanism as that disposed in the first substrate is not disposed in the second substrate.

(9) Alternatively, the transmitter-receiver includes a heat transportation mechanism for transporting heat generated by the control IC to the antenna switch or the filter.

Further, the provision of such forms can provide the high-performance transmitter-receiver which can function even in wide operating temperature.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1 is a diagram schematically illustrating a basic circuit of a capacitor system according to the present invention;

FIG. 2 is a perspective view schematically illustrating a variable capacitor;

FIG. 3 is a perspective view schematically illustrating a fixed capacitor;

FIGS. 4A to 4G show an example of a manufacturing method of a fixed capacitor;

FIG. 5 is a sectional view of a capacitor system according to the present invention;

FIG. 6 is a diagram schematically illustrating an example of a circuit for comparison;

FIG. 7 is a graph showing a conceptual range of capacitance adjustable by a variable capacitor structured according to the present invention;

FIG. 8 is another graph showing a conceptual range of capacitance adjustable by a variable capacitor structured according to the present invention;

FIG. 9 is a diagram schematically illustrating a circuit according to another embodiment of the present invention;

FIG. 10 is a sectional view showing a schematic structure according to an embodiment of the present invention;

FIG. 11 is a sectional view showing a schematic structure of an example for comparison;

FIG. 12 is a sectional view showing a schematic structure according to an embodiment of the present invention;

FIG. 13 is a sectional view showing a schematic structure according to another embodiment of the present invention;

FIG. 14 is a block diagram schematically illustrating a system according to an embodiment of the present invention;

FIG. 15 is a sectional view showing a schematic structure according to an embodiment of the present invention;

FIG. 16 is a sectional view showing a schematic structure according to an embodiment of the present invention;

FIG. 17 is a sectional view showing a schematic structure according to an embodiment of the present invention;

FIG. 18 is a sectional view showing a schematic structure according to an embodiment of the present invention;

FIG. 19 is a sectional view showing a schematic structure according to an embodiment of the present invention; and

FIG. 20 is a sectional view showing a schematic structure according to an embodiment of the present invention.

### DETAILED DESCRIPTION OF THE INVENTION

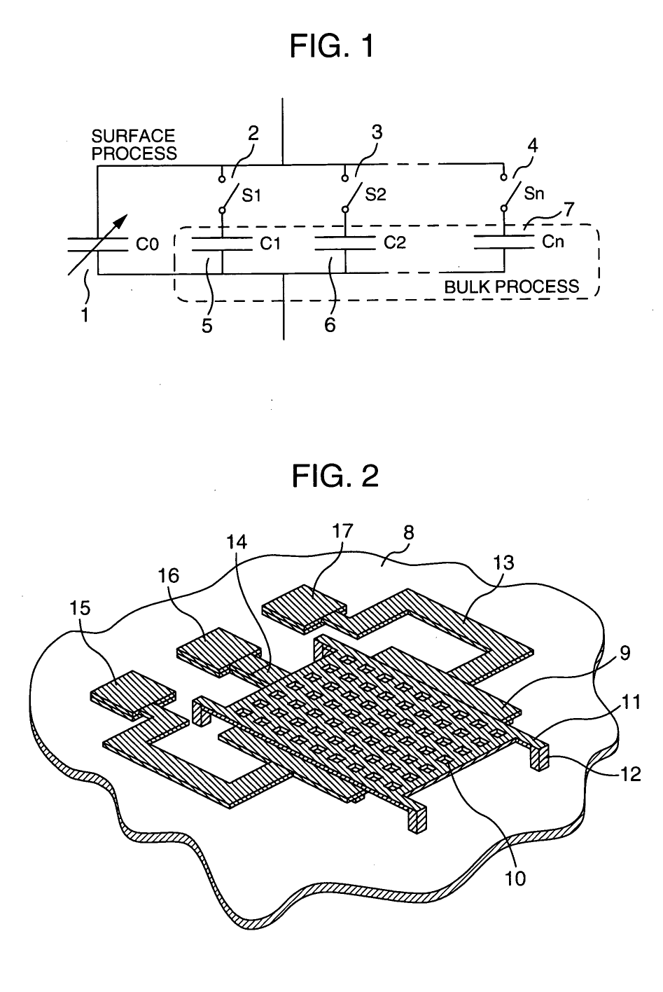

Embodiments of the present invention are now described with reference to FIGS. 1 to 20. The present invention is not limited to the embodiments disclosed in the specification and does not impede modification based on known technique and forms constituting known technique in future.

FIG. 1 is a diagram schematically illustrating a circuit according to an embodiment. A variable capacitor of the present invention includes a variable capacitor 1 (C0) and switches 2(S1), 3(S2) and 4(Sn) fabricated by the surface process and fixed capacitors 5(C1), 6(C2) and 7(Cn) fabricated by the bulk process. In FIG. 1, the numbers of switches 2, 3 and 4 and fixed capacitors 5, 6 and 7 are n, although the number of the switches 2 to 4 may be different from that of the fixed capacitors 5 to 7 when the configuration of the switches is a tournament system or the like. However, the description of the embodiment is continued as it is on the assumption that the respective number is the same. Further, it is assumed that the capacitance of the variable capacitor 1(C0) can be continuously adjusted around the capacitance C0 in the range of C0±Δc and the capacitance values of the capacitors 5, 6 and 7 are C1, C2 and Cn, respectively.

In FIG. 1, the switch 2(S1) is connected to the capacitor 5(C1), the switch 3(S2) to the capacitor 6(C2) and the switch 4(Sn) to the capacitor 7(Cn). For example, when only the switch S1 is on, a capacitance value C of the variable capacitor of the embodiment is C=C0+C1±Δc and is adjustable.

In the embodiment shown in FIG. 1, the variable capacitor 1 is preferably a parallel plate type capacitor as shown in FIG. 2. The parallel plate type capacitor shown in FIG. 2 is composed of a layer of a fixed electrode 9 formed on an insulating layer 8 on a substrate and a layer of a movable electrode 10 formed movably in the direction of thickness of the layer. The variable capacitor 1 includes first and second electrode layers formed on a main surface of the substrate with space therebetween and a driving mechanism for controlling the space between the first and second electrode layers.

The fixed electrode 9 may be formed to be spaced or separated from the insulating layer 8 as shown in FIG. 2. Further, the movable electrode 10 is fixed to an anchor 12 through a beam-like suspension 11, and the suspension 11 and the movable electrode 10 can be deformed to thereby vary the distance and the capacitance between the electrodes. The opposite surfaces of the fixed electrode 9 and the movable electrode 10 are preferably formed of metal layers plated by gold or the like. The suspension 11 and the anchor 12 may be formed into different shape from that of FIG. 2.

In FIG. 2, the fixed electrode 9 and the movable electrode 10 are connected to electrode pads 15, 16 and 17 through wiring structures 13 and 14, respectively. At least one of the electrode pads is connected to the ground and a bias voltage can be applied between the grounded electrode pad and the other electrode pad not short-circuited to thereby exert electrostatic suction force between the fixed electrode 9 and the movable electrode 10 so that the distance between the electrodes can be changed. The variable capacitor of FIG. 2 includes the electrode pads for common use in order to apply the bias voltage and store and discharge electric charges upon mounting in a product, although a circuit for the bias voltage may be provided separately from a circuit used for the capacitor.

According to the present invention, since the variable capacitor having the movable portion and the switches can be formed on the same surface side of the substrate by the surface process and the fixed capacitors having no movable portion can be formed on the opposite side of the substrate, the capacitance of the variable capacitor can be adjusted continuously in a wide range while the substrate occupation area of the MEMS variable capacitor having the tendency to increase the substrate occupation area is kept small.

The variable capacitor 1 may have another structure instead of the parallel plate type structure as shown in FIG. 2 as long as the capacitance thereof can be adjusted continuously.

Accordingly, the variable capacitor can include the fixed electrode 9 constituting a first electrode (ground), the movable electrode 10 constituting a second electrode (power supply) disposed opposite to the first electrode with space therebetween and an actuator (electrostatic or thermal) constituting a driving mechanism for controlling the space between the first and second electrodes, as an example that the electrical bias is applied to vary the capacitance. The variable capacitor of another form having a movable mechanism formed into the teeth of a comb can be structured to control the opposite (overlapped) area of the first and second electrodes.

The substrate can be made of, for example, semiconductor (silicon, GaAs) or glass (SiO₂, Al₂O₃).

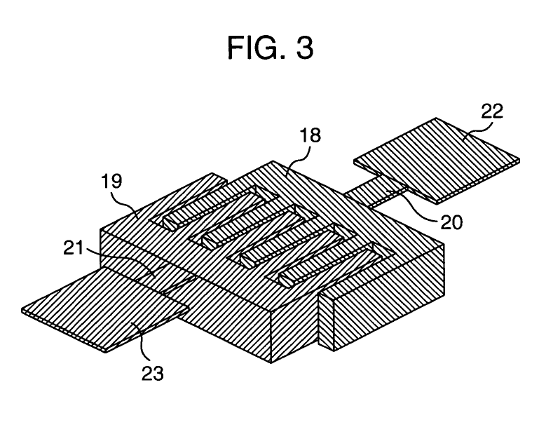

FIG. 3 is a perspective view schematically illustrating an example of the fixed capacitor of the embodiment. The fixed capacitors 5, 6 and 7 of the embodiment have preferably the comb structure as shown in FIG. 3, while the fixed capacitors may have any other structure as long as the fixed capacitors can be formed on the back side of the substrate.

In FIG. 3, the fixed capacitors 5, 6 and 7 of the embodiment are constituted by comblike electrodes 18 and 19 formed on the substrate (not shown) in opposing relation to each other. The comblike electrodes 18 and 19 are connected to electrode pads 22 and 23 through wiring structures 20 and 21, respectively. If the dimensions and the positional relation of the comb structures are fixed, the movable portion is not forced to be formed. Accordingly, since any sacrificial layer on the manufacturing process is not required, only the bulk process can be used to form condensers or capacitors if the comblike electrodes are processed by the anisotropic etching and the surfaces of the electrodes, the wiring structure and the electrode pads are formed by the processing method of electroless plating.

In FIG. 3, the capacitance of the fixed capacitors 5, 6 and 7 is adjusted by parameters including width, length, height, distance between electrodes, material used to form the surface and the like of the comblike electrodes 18 and 19. Particularly, when the dimensions of a single tooth of the comblike electrodes and the distance between opposite teeth thereof are fixed, the capacitance can be adjusted in accordance with the number of teeth and accordingly the fixed capacitors of four kinds having the ratio of capacitance of 1:2:4:8, for example, can be formed. In this case, when a single or any number of capacitors are connected in parallel, a combination of stepwise capacitance having 10 or more steps such as 1, 2, 1+2=3, 4, 1+4=5, 2+4=6, 1+2+4=7, 8, 1+8=9 and 2+8=10 can be realized. When the capacitance of the capacitor having the smallest capacitance is small as an absolute value, the step width of the capacitance can be made small while when it is large, the step width can be made large.

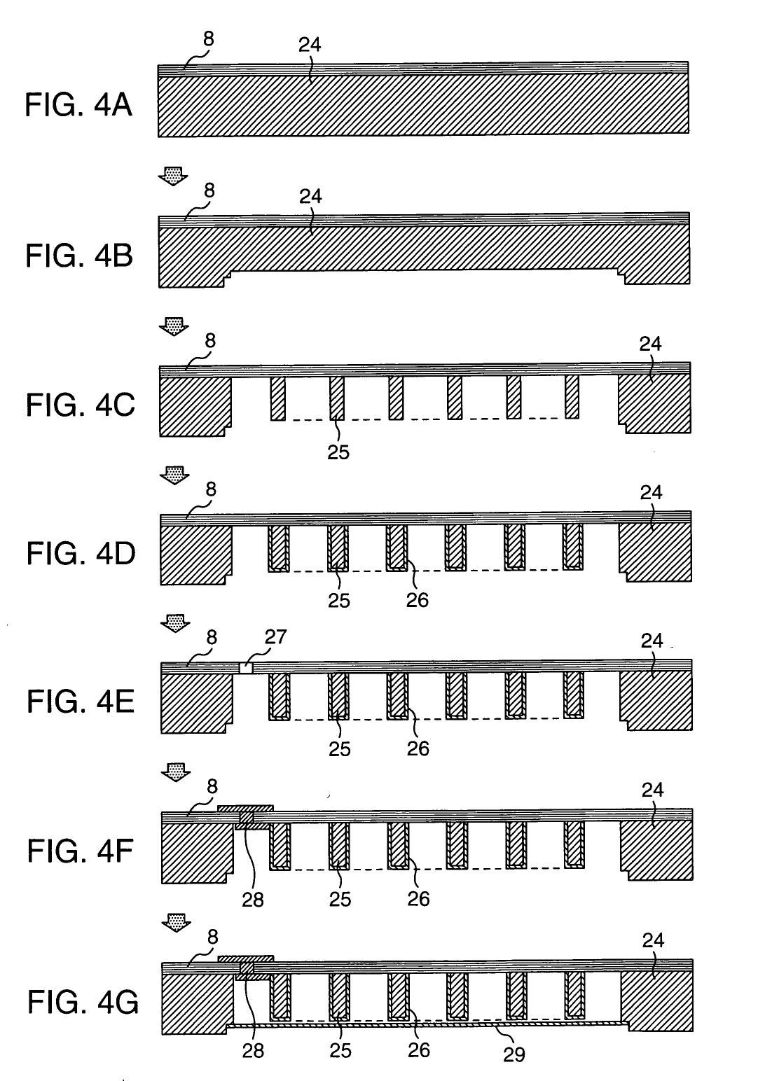

An example of a manufacturing method of the fixed capacitor shown in FIG. 3 is shown in FIGS. 4A to 4G. In FIGS. 4A to 4G, sections of a substrate are shown in order of main processes. The substrate 24 having an insulating layer 8 formed on the surface thereof is first prepared. The substrate 24 may be made of any material as long as the bulk process can be applied thereto, while it may be compound semiconductor such as, for example, gallium arsenide and silicon (Si) having high insulation properties. In FIG. 4A, there is nothing on the insulating layer 8, although a layer made of Si or the like may be disposed on the insulating layer like SOI (Silicon On Insulator) substrate. When it is considered that the variable capacitor, the switches 2, 3 and 4 or a high-frequency transmission line is formed on the insulating layer 8 by the surface process, any three-dimensional structure is formed before or after the processes shown in FIGS. 4A to 4G or in parallel with the processes.

Next, as shown in FIG. 4B, the substrate 24 is partially etched by a predetermined thickness in the thickness direction thereof by the anisotropic etching. Further, as shown in FIG. 4C, the substrate is removed except structural portions to be left finally such as comblike electrodes. FIG. 4C shows a section of only one of the plurality of opposite comblike electrodes 18 and 19. Then, as shown in FIG. 4D, metal-plated layer 26 such as gold-plated layers are laminated on the comblike electrodes 25 by means of the electroless plating technique. At this time, attention should be paid not to short-circuit the electrodes 18 and 19 constituting the capacitor.

The process of FIG. 4E is not necessarily required to be carried out after the process of FIG. 4D, while a through-hole 27 that penetrates the insulating layer 8 is formed after the etching of FIG. 4C. The through-hole 27 and at least the back side thereof are embedded by wiring structure 28 such as gold-plated layer and further connected to the metal-plated layers 26 on the comblike electrodes 25 to thereby make it possible to form the comblike electrodes 18 or 19 and electrically connect the electrodes to devices mounted on the surface of the insulating layer 8. The same structure as the above can be formed opposite thereto to thereby form the fixed capacitors 5, 6 and 7 on the back side of the substrate by the bulk process. Further, as shown in FIG. 4G, the portion above the electrodes is sealed by a metal cap 29 finally and if possible the pressure within the sealed portion is reduced, so that the fixed capacitors can be formed with higher reliability.

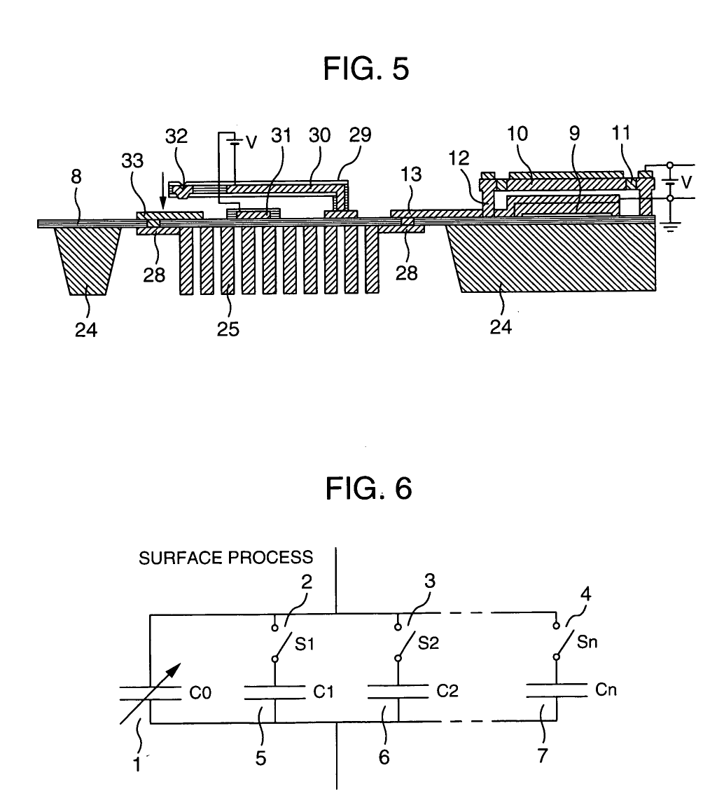

FIG. 5 is a sectional view schematically illustrating the variable capacitor system. The variable capacitor system of the embodiment includes the variable capacitor 1 having continuously controllable capacitance and the fixed capacitors 5, 6 and 7.

More particularly, the capacitor having the variable capacitance and the switches can be formed on the surface of the substrate by the surface process and the capacitors having the fixed capacitance can be formed on the back side of the substrate by the bulk process. The variable capacitor 1 and the fixed capacitors 5, 6 and 7 constituting the system can utilize the structure of the above-mentioned embodiments. As an example thereof, the main variable capacitor having the movable portion formed on the surface of the substrate by the surface process can constitute the parallel plate type capacitor having the distance between electrodes which is varied by electrostatic force and the secondary fixed capacitors formed on the back side of the substrate by the bulk process can constitute the capacitors having the comblike structure.

The system of an embodiment includes the variable capacitor 1 provided with a driving mechanism for varying the capacitance stored between a pair of electrodes formed on the main surface of the substrate and the fixed capacitors 5, 6 and 7 having the fixed capacitance stored between a plurality of pairs of electrodes formed on the back side of the substrate opposite to the surface on which the variable capacitor 1 is formed. The variable capacitor 1 and the fixed capacitors 5, 6 and 7 are electrically connected by wiring to thereby constitute the circuit. The circuit includes switches 2, 3 and 4 formed on the main surface of the substrate for electrically connecting the variable capacitor 1 and a capacitor or capacitors selected from the plurality of fixed capacitors 5, 6 and 7.

The switches 2, 3 and 4 include first and second wiring layers formed on the same surface as that of the substrate on which the variable capacitor 1 is formed and having the space formed therebetween, a beam supported to the substrate and having a conductive junction, and a driving mechanism for electrically connecting the junction to the first or second wiring layer.

Further, the variable capacitor 1 and the fixed capacitors are formed in parallel electrically and the total capacitance of the fixed capacitors is larger than the maximum capacitance of the variable capacitor. The switches are to control the number of the fixed capacitors connected to the circuit electrically. Consequently, there is provided a capacitance adjusting function which can adjust the capacitance continuously within the variable range of the capacitance of the main capacitor around the respective capacitance dispersed at wide intervals.

In the switch structure shown in FIG. 5, a cantilever beam 29 is bent by electrostatic suction force produced by a bias voltage applied between electrodes 30 and 31 to thereby bring a metal contact 32 into contact with a wiring structure 33, so that the switch is connected or turned on to conduct a current directly, although the contact 32 may not be brought into contact with a signal transmission line directly and the switch may be a capacitive switch depending on the circuit configuration.

The system shown in FIG. 5 can include, for example, a fine-tunable variable capacitor capable of being adjusted with high accuracy and narrow width, and step-tunable fixed capacitors having a plurality of capacitors and the capacitance which can be adjusted widely with low accuracy by switching and combination of the plurality of capacitors. The system can be applied to, for example, portable telephones, radio LANs and RF circuits which can transmit and receive signals having a plurality of frequency bands and including the single capacitor system.

A receiver or a transmitter-receiver having the above form is provided. The receiver includes, for example, antennas provided in corresponding manner to a plurality of frequencies (e.g. a plurality of antennas each provided for each frequency), an antenna switch which can switch the antennas, a filter (for removal of noise and, for example, provided for each frequency) supplied with signal from the antenna through the antenna switch, an amplifier supplied with a signal passing through the filter, an RF circuit (analog circuit) supplied with a signal produced by the amplifier and a control IC (received signal*image data/audio signal etc.) supplied with a signal passing through the RF circuit.

In FIG. 5, when the switch is connected or turned on, the variable capacitor 1 is connected in parallel to the fixed capacitor 5, 6 or 7 through the switch and the wiring structures 33 and 28. Consequently, the capacitance range obtained by adding the stepwise capacitance obtained by a combination of prescribed capacitance values of the fixed capacitors to the capacitance corresponding to the width of the variable capacitance area of the variable capacitor 1 can be adjusted by the variable capacitor according to the present invention.

A capacitor module can be structured by, for example, the variable capacitor constituting the main capacitor and the switches formed by the surface process of the micromachining technique and the fixed capacitors constituting the secondary capacitors formed by the bulk process. Alternatively, the micro-electromechanical system (MEMS) capacitors and the switches can be formed on both of the surface and the back side of the substrate.

FIG. 6 illustrates a circuit configuration as an example for comparison in which the variable capacitor having the same function as that of the embodiment is formed on the same surface of the substrate by the surface process, for example, or formed by the combination of laminated ceramic capacitor, semiconductor switch, varicap and the like, although since all of structural elements are mounted on the same side of the substrate, there is a problem that the mounting area is largely increased. In the embodiment, the fixed capacitance structural element having no moving portion can be formed on the back side of the substrate to thereby reduce the mounting area having the same function.

Further, it is desirable that the variable capacitor 1 and the fixed capacitors 5, 6 and 7 are formed electrically in parallel and the total capacitance of the fixed capacitors is larger than the maximum capacitance of the variable capacitor. The switch preferably controls the number of fixed capacitors connected electrically to the circuit.

Alternatively, it is desirable that the increased capacitance at each step of the total fixed capacitance in case where the total capacitance of the fixed capacitors connected electrically to the circuit is increased by combining the switches 2, 3 and 4 is formed to be smaller than the variable capacitance range of the variable capacitor. Consequently, the capacitance can be adjusted continuously over the range from the lower limit of the variable capacitance of the main capacitor to the sum of the maximum capacitance obtained by combining the secondary capacitors and the upper limit of the variable capacitor of the main capacitor.

Further, it is desirable that the increased capacitance in case where the total capacitance of the fixed capacitors connected electrically to the circuit by the switches is increased is formed to be larger than the variable capacitance range of the variable capacitor.

Consequently, the capacitance can be adjusted continuously within the variable capacitance range of the main capacitor around the respective capacitance dispersed at wide intervals.

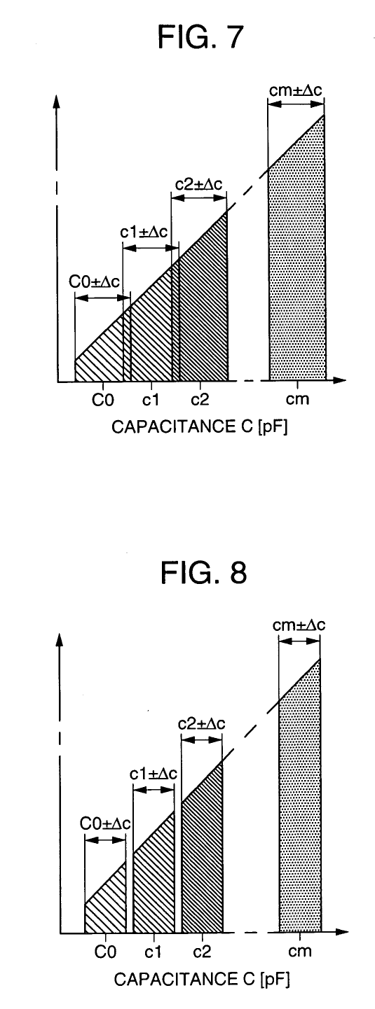

FIGS. 7 and 8 show adjustable capacitance ranges of the variable capacitor formed by the present invention. In FIGS. 7 and 8, CO represents an average value of the variable capacitance area of the variable capacitor 1, ±Δc represents a width of the variable capacitance area of the variable capacitor 1, and c1, c2 and cm represent stepwise capacitance values that can be adjusted by combination of the fixed capacitors 5, 6 and 7.

FIG. 7 shows the case where the width of the capacitance adjustable by the fixed capacitors is smaller than ±Δc and FIG. 8 shows the case where it is larger. As apparent from FIGS. 7 and 8, when the width of the stepwise capacitance adjustable by combination of the fixed capacitors is smaller, the capacitance can be adjusted continuously from C0−Δc to cm+Δc, while when the width is larger, the capacitance can be adjusted in the ranges dispersed at intervals of the capacitance adjustable in the range of ±Δc around a representative capacitance. The capacitor configured as FIG. 8 is suitable for the capacitor mounted in the circuit for processing signals having extremely different frequency bands.

In order to adjust the capacitance of the variable capacitor of the embodiment, a control circuit of the capacitor 1 and the switches is required, although its drawing is omitted.

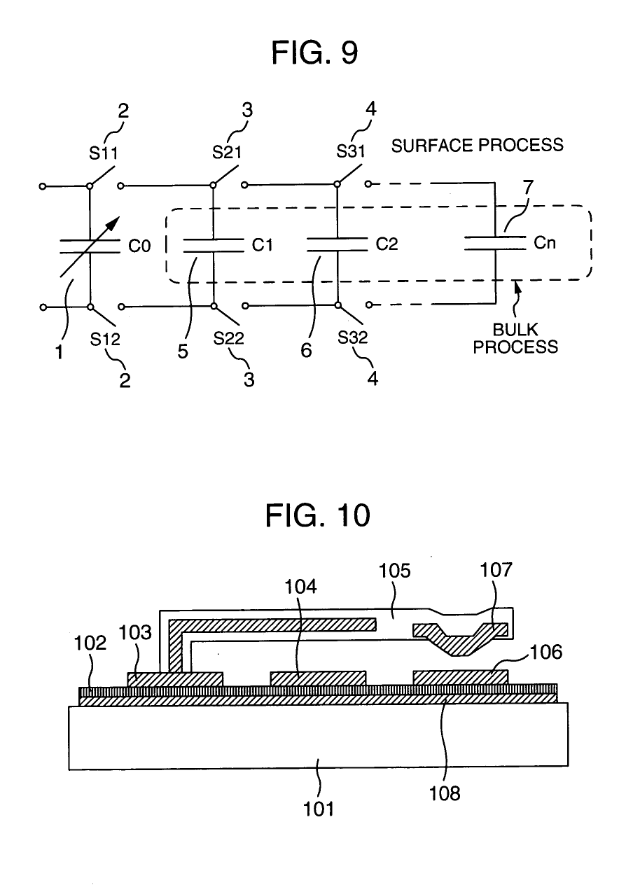

Another embodiment of the present invention is now described with reference to FIG. 9 illustrating a circuit configuration of the embodiment. The embodiment is also the same in that the variable capacitor 1 and the switches 2, 3 and 4 formed by the surface process and the fixed capacitors 5, 6 and 7 formed by the bulk process constitute the circuit, while it is different from other embodiments in that switches 2 (S11 and S12), switches 3 (S21 and S22) and switches 4 (S31 and S32) are connected in order of the description to thereby select the interval of the fixed capacitor by n kinds of previously fixed combinations. When the capacitance values of the fixed capacitors 5(C1), 6(C2) and 7(Cn) are different from one another by about several times, combination of fixed capacitors having the capacitance different by about one figure can be selected in the variable capacitance area as shown in FIG. 8.

Although not shown, when the variable capacitor of the present invention is formed into a package, the surface side including movable portion can be sealed hermetically and the high-frequency transmission path and the circuit wiring portion necessary to control the switches and the capacitors can be formed to be penetrated from the surface to the back side of the substrate by the back-side etching and plating process and connected to the outside of the package by bump.

Another embodiment is also described below.

The following embodiment can be applied to any of the above-mentioned switches. In this case, it can configure a MEMS electronic device with improved reliability.

Referring now to FIGS. 10, 12 and 13, embodiments are described concretely. The present invention is not limited to the embodiments disclosed in the specification and does not impede modification based on known technique and forms constituting known technique in future.

FIG. 10 is a sectional view illustrating an example of a MEMS device having a temperature control function of the present invention. More particularly, FIG. 10 illustrates, as an example, a microswitch of a device formed by the micro-electromechanical system (MEMS) technique and that is a MEMS switch operating in response to bending of a beam (e.g. cantilever beam).

A substrate 101 is formed and an insulating layer 102 is formed on the substrate 101. Constituent elements are formed on the insulating layer 102 by the surface process. A beam 105 supported by the substrate 101 is formed three-dimensionally on the substrate 101. The cantilever beam 105 constituting a body structure of the switch includes an electrode layer 103 formed on the insulating layer 102 and a conductive portion connected electrically to the electrode layer 103 and constitutes a driving mechanism of the beam. When a bias voltage is applied between the electrode layer 103 and an electrode layer 104 formed on the insulating layer 102, the cantilever beam is bent by electrostatic suction force produced between the electrodes, so that a contact 107 formed of conductive layer can be connected to an electrode layer 106 to thereby conduct an electrical signal. The electrode layer 106 includes two wiring members disposed on the insulating layer 103 with space therebetween and is structured to connect both the wiring members electrically when the contact 107 is brought into contact with the electrode layer 106. A MEMS device which is a structural element having a three-dimensional structure manufactured by the semiconductor manufacturing process in the embodiment and which is served in the application in which electrical signals are treated has a temperature control function 108 provided on the substrate 101 in the area corresponding to the beam 105.

Temperature control means having the temperature control function 108 is considered to be formed by a heater layer such as, for example, a thermoelectric element layer by means of the thin film growth process. If there is a method of controlling an operating temperature of the switch to a predetermined range, another measure can be used.

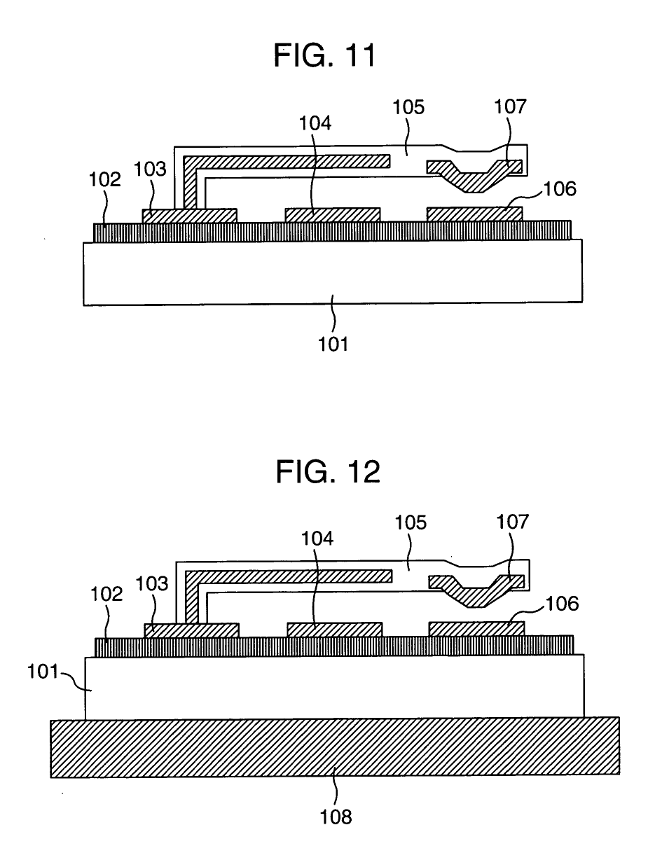

As described above, a microswitch which operates mechanically in response to the electrical signal is provided on the substrate to thereby stabilize the operating temperature of the MEMS structure having the movable portion within a predetermined range without influence of the ambient temperature and heat generated by semiconductor devices mounted mixedly in comparison with a microswitch structure without the temperature control function 108 of FIG. 11. Accordingly, the operating characteristic such as, for example, a driving voltage for operating the switch can be always kept substantially fixed. Accordingly, the MEMS device more excellent from the viewpoint of the reliability design and the operation control condition and the apparatus including the device can be provided.

Since the MEMS device has the characteristics varied depending on temperature, an applied voltage necessary for the same operation is changed and the applied voltage must be higher as the temperature is lower. Accordingly, the provision of this structure can effectively prevent the device from being disabled when the applied voltage is reduced below the driving voltage of the switch in case where a battery capacity is reduced. This is particularly effective for the case where the environment of the operating temperature is changed as portable terminals. For example, the device can be used in an RF circuit of the portable terminal to thereby configure a compact terminal. In this case, it is effective that the RF circuit can cope with multiple frequencies. Further, when the battery capacity is small, heat used by temperature control means is preferably discharged and drawn in without using the battery. There is increased the possibility that a leakage current is increased in a high-frequency band (several GHz or more) in semiconductor switches, whereas in the present invention such a microswitch can be used to configure the device that can cope with the high-frequency band even if the ambient temperature is changed.

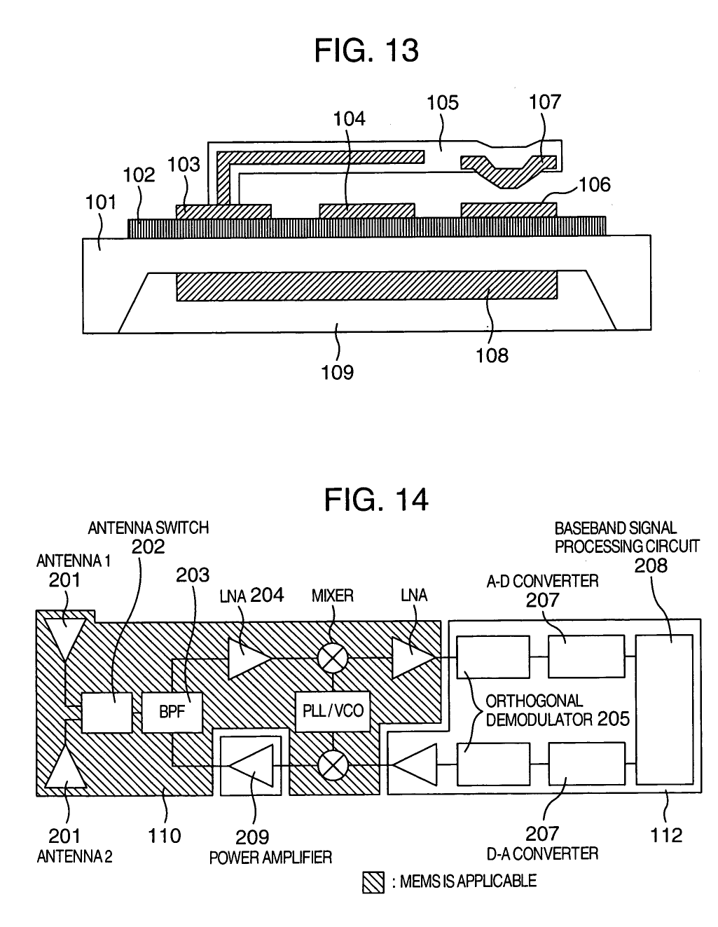

FIG. 12 shows another embodiment. This embodiment can include the configuration described with reference to FIG. 10 basically, while in the embodiment the temperature control means 108 is formed on the side opposite to the surface of the substrate 101 on which the beam 105 is formed. The whole of the substrate 101 on which the MEMS structure is mounted are carried or mounted on the temperature control means 108. Alternatively, as shown in FIG. 13, a cavity 109 may be formed in the back side of the substrate 101 and the temperature control means 108 may be disposed in the cavity. In this case, a thermoelectric element such as, for example, Peltier element can be mounted as the temperature control means 108.

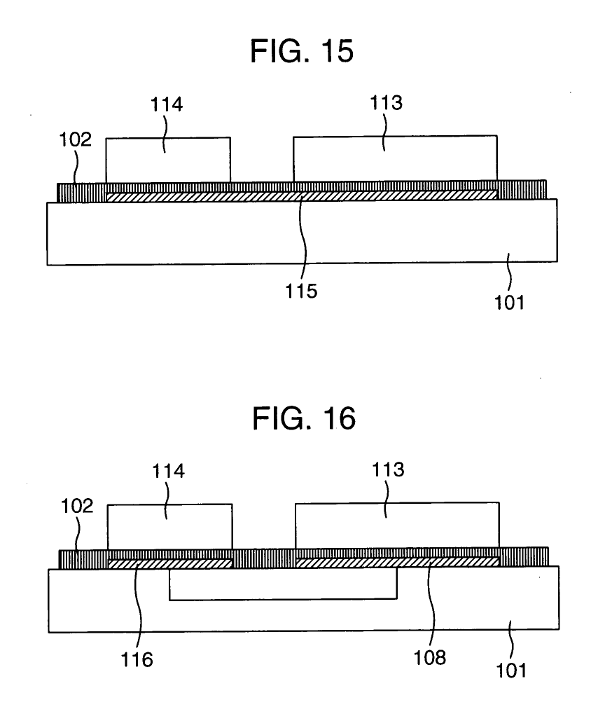

Another embodiment of the present invention is now described with reference to FIGS. 14 and 15. This embodiment shows an example of a transmitter-receiver to which the configuration described with reference to FIG. 10 is applied. FIG. 14 is a block diagram schematically illustrating an example of a transmitter-receiver circuit of a portable apparatus such as a portable telephone. The transmitter-receiver circuit is not limited thereto.

As shown in FIG. 14, the transmitter-receiver circuit of the portable telephone and the like includes a plurality of antennas 201 provided in corresponding manner to wavelengths, an antenna switch 202 for switching the antennas 201, a band-pass filter (BPF) 203 supplied with a signal from the antenna switch 202, a low-noise amplifier (LNA) 204 supplied with a signal from the BPF 203, an orthogonal demodulator 205 supplied with a signal produced by the amplifier, an analog-to-digital (A/D) converter 107 supplied with a signal produced by the orthogonal demodulator 205 and a baseband signal processing circuit 208 constituting a control IC supplied with a signal produced by the A/D converter 107. The baseband signal processing circuit 208 is supplied with a signal and produces a signal. The signal produced by the control IC may be transmitted through D/A converter 207, orthogonal demodulator 205, power amplifier 209, BPF 203, antenna switch 202 and a predetermined antenna 201, for example.

Further, the apparatus of the embodiment includes a plurality of substrates on which the constituent devices are mounted. The substrates include a first substrate 110 on which devices to which elements manufactured by the MEMS technique can be applied are mounted and a substrate 112 on which devices to which MEMS elements such as the control IC can be difficult to be applied are mounted. Such a transmitter-receiver circuit is preferable to be formed into SIP (System In Package) or SOC (System On Chip) in order to reduce the circuit area.

The MEMS element illustrated in FIG. 10 is applied to a part of such a transmitter-receiver circuit. It is an antenna switch as an example. Alternatively, the element may be applied to a filter or the like which adopts the variable capacitor. This is formed on at least the first substrate 110. These devices have a problem of deterioration of characteristics due to the operating temperature. On the other hand, semiconductor elements to which the MEMS devices such as the power amplifier 11 and the control IC as the baseband signal processing circuit are difficult to be applied are mixedly mounted on the same package substrate 112 on which the MEMS elements are mounted.

In the transmitter-receiver circuit of the terminal used in the radio communication of the portable telephone and the like, since the heat loss of the power amplifier 209 is very large, the power amplifier 209 can be mounted on the second substrate 112 in order to prevent the heat generated from the power amplifier from influencing the MEMS elements. On the other hand, if the heat can be transmitted to the MEMS elements effectively upon reduction of temperature, the deterioration of characteristics of the MEMS elements can be prevented. When such a viewpoint can be considered important, the power amplifier 209 can be mounted on the first substrate 110.

Further, the temperature control mechanism can be provided in the filter to configure the apparatus provided with a high-performance filter circuit which can utilize the frequency band in the limited range effectively even if the traffic of radio communication is increased.

FIG. 15 illustrates another embodiment of the present invention. The MEMS structure of the embodiment is illustrated in section. A MEMS element 113 having a movable portion or characteristics varied depending on the operating temperature and a semiconductor element 114 are mixedly mounted on the substrate 101. The circuit shown in FIG. 14 is used. In FIG. 15, wiring portions for connection are simplified. The MEMS element 113 may be the antenna switch 202 or filter 203. The semiconductor element 114 may be the control IC or power amplifier. The MEMS element 113 may include a passive element such as a SAW (Surface Acoustic Wave) filter. In FIG. 15, the MEMS element 113 and the semiconductor element 114 are thermally connected by heat transportation means 115 formed on or within the substrate. The heat transportation means 115 may be preferably a heat diffusion plate such as metal layer and metal plate. Alternatively, the heat transportation means 115 may be measures, such as a heat pipe or a heat diffusion plate having high heat conductivity filled with graphite sheet or carbon nano-tube, that can effectively diffuse heat generated by the semiconductor element 114 in the direction of substrate plane toward the MEMS element 113.

In the embodiment, since heat generated by the semiconductor element 114 can be transmitted to the mounting position of the MEMS element 113 effectively, the rigidity of material forming the MEMS element is not increased and the MEMS element can be operated by a predetermined bias voltage even when the operating temperature is very low, for example. The MEMS element 113 and the semiconductor element 114 are mounted on the common substrate, although these may be separated to be mounted on a plurality of substrates.

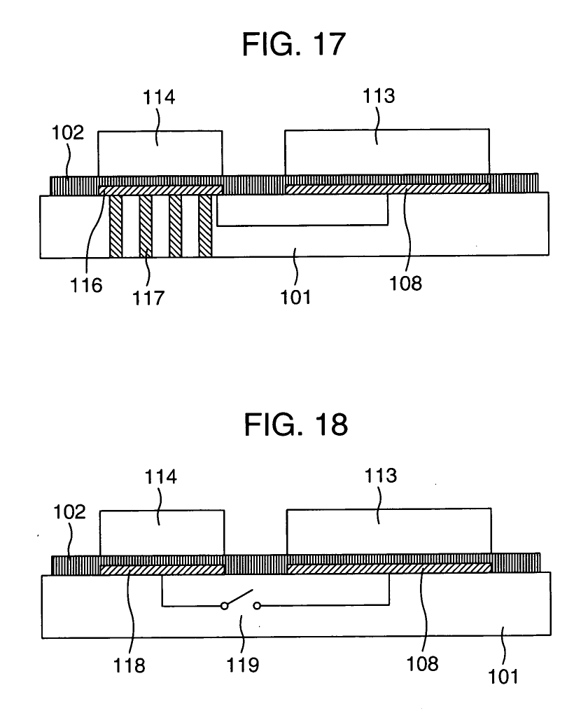

Another embodiment of the present invention is now described with reference to FIGS. 16 and 17. This embodiment can include the form described with reference to FIG. 15. In the embodiment, a thermoelectric conversion element 116 is disposed between the semiconductor element 114 and the back side of the substrate 101, that is, on the way of a radiation path of heat generated by the semiconductor element 114 to collect part of the heat generated by the semiconductor element 114 as electric energy. The electric energy is utilized as driving energy of the temperature control means 108 of the MEMS element 113 after it is stored once or directly.

According to the embodiment, since part of the heat generated by the semiconductor element 114 can be collected and utilized as the energy for temperature control of the MEMS element 113, the device of the embodiment can be used as a product without deterioration of the characteristics of the MEMS element 113. When the collected energy is lacking for the temperature control, a power supply such as a battery constituting a current supply source to the semiconductor element 114 and the MEMS element 113 may be applied to the temperature control means 118. Further, when the operating temperature of the MEMS element 113 falls in the range that the characteristics thereof are not influenced even if there is no control of the temperature control means 108, the electric energy collected by the thermoelectric conversion element 116 can be stored in a capacitor as reserve energy usable when the temperature control is actually required.

The temperature control is needed greatly at the low operating temperature that the rigidity of the MEMS element constituting material is increased. Accordingly, since the method of increasing the temperature at only low operating temperature is a countermeasure to deterioration of characteristics, the temperature control means 108 may use a heater such as a thin-film resistor.

Further, as shown in FIG. 17, since a thermal resistance in the heat radiation path between the semiconductor element 114 and the back side of the substrate 101 is reduced and the heat generated by the semiconductor element 114 is transmitted in the direction of the back side effectively within a predetermined range in the substrate 101, heat diffusion members 117 such as radiation veer may be disposed in the area of the substrate where the semiconductor element 114 is disposed. In this case, it is desirable that the heat diffusion members 117 such as veer are not disposed in the area where the MEMS element 113 is formed. A heat transportation device or the heat diffusion function for radiating the heat generated as loss outside of the substrate can be provided in the periphery of the semiconductor element in the substrate thereby reduce influence affecting to the operating temperature of the micromachining structure by the heat generated by the semiconductor element.

Another embodiment of the present invention is now described with reference to FIG. 18. This embodiment can include the form described with reference to FIG. 15 basically. In the embodiment, thermal energy collection and diffusion means 118 is disposed in the heat radiation path connecting the semiconductor element 114 and the back side of the substrate 101 and connected to the temperature control means 108 of the MEMS element 113 through a switch 119. The thermal energy collection and diffusion means 118 may be the thermoelectric conversion element as the embodiment of the present invention shown in FIG. 16 or may be the heat diffusion plate as the embodiment of the present invention shown in FIG. 17.

Since the driving voltage must be increased when the characteristics of the MEMS element 113 are deteriorated, particularly when the operating temperature is reduced and the rigidity of the material forming the MEMS element 113 is increased, the need for the temperature control is relatively small when the operating temperature is higher than the design temperature. Accordingly, the temperature of the MEMS element 113 is monitored and only when the operating temperature thereof is lower than a predetermined temperature, the temperature control means 108 and the thermal energy collection and diffusion means 118 can be connected electrically or thermally so that the temperature of the MEMS element 113 cannot be reduced extremely. Part of heat generated as loss by operating the semiconductor element is electrically collected by measures such as the thermoelectric conversion element and heating means that is operated by the collected electrical energy is disposed as a temperature increasing function of the micromachining structure, so that when the operating temperature of the micromachining structure is higher than a predetermined temperature, the temperature increasing function is not energized and when the operating temperature is lower than the predetermined temperature, the temperature increasing function is energized.

Further, even in the embodiment, as shown in FIG. 17, since a thermal resistance in the heat radiation path between the semiconductor element 114 and the back side of the substrate 101 is reduced and heat generated by the semiconductor element 114 is transmitted in the back side direction effectively within a predetermined range in the substrate 101, heat diffusion members 117 such as heat radiation veer may be disposed in the substrate.

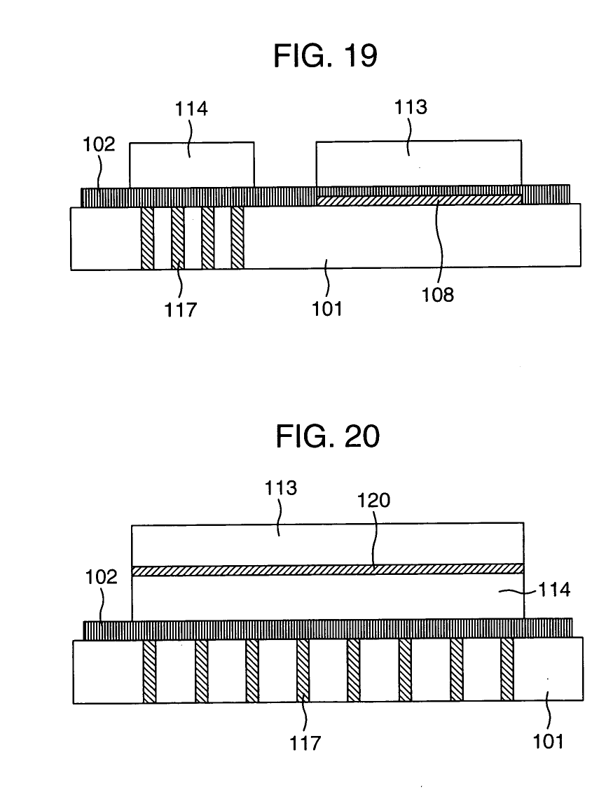

Another embodiment of the present invention is now described with reference to FIG. 19. This embodiment can include the form described with reference to FIG. 15 basically. In the embodiment, the temperature control means 108 of the MEMS element 113 is controlled by a current directly supplied from the power supply such as a battery and heat generated by the semiconductor element 114 is radiated to the back side of the substrate 101 through the heat diffusion members 117 effectively. In the embodiment, since the semiconductor element 114 required to radiate the heat generated therefrom effectively and the MEMS element 113 required to keep its operating temperature within a predetermined range in the vicinity of the design point can be mounted on the same substrate 101 thermally independently, the MEMS element 113 and the semiconductor element 114 designed separately can be mounted on the same substrate relatively easily.

Another embodiment of the present invention is now described with reference to FIG. 20. This embodiment can include the form described with reference to FIG. 15 basically. In the embodiment, the semiconductor element 114 and the MEMS element 113 are laminated in the direction vertical to the plane of the substrate. Heat insulation structure of the surface opposite to the semiconductor element 114 and temperature control means 120 having temperature control structure can be disposed between the semiconductor element 114 and the MEMS element 113 to thereby transmit heat generated by the semiconductor element 114 and the temperature control means 120 to the back side of the substrate 101 through the heat diffusion members 117 effectively, so that the temperature of the MEMS element 113 can be kept within a predetermined range around the design value by the temperature control means 120.

As described above, according to the embodiments, the temperature of the MEMS element having the possibility that the characteristics thereof are deteriorated remarkably depending on the operating temperature can be kept within the predetermined range around the design point or to be a predetermined value or more. In the embodiments of the present invention, the semiconductor element 114 and the MEMS element 113 are mounted on the same side of the substrate 101, although both the elements may be mounted on different sides of the substrate or part of the semiconductor element 114 and the MEMS element 113 may be mounted on the different side as long as the temperature of the movable portion or the MEMS structure having the characteristics influenced by the operating temperature greatly is kept within the predetermined range or to be the predetermined value or more.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A variable capacitor system comprising:
a substrate;
a variable capacitor including a driving mechanism for varying capacitance stored by a pair of electrodes formed in a main surface of said substrate;
a plurality of fixed capacitors having fixed capacitance stored by a plurality of pairs of electrodes formed in an opposite side of said main surface;
wiring means for electrically connecting said variable capacitor and said fixed capacitors; and
a switch disposed in said main surface of said substrate to electrically connect said variable capacitor and a capacitor or capacitors selected from said plurality of fixed capacitors.

2. A variable capacitor system according to claim 1, wherein
said variable capacitor includes first and second electrode layers formed on said main surface of said substrate with space therebetween and a driving mechanism for controlling said space between said first and second electrode layers; and
said switch includes first and second wiring layers formed on said main surface of said substrate with space therebetween, a beam supported to said substrate and having a conductive junction, and a driving mechanism for bring said junction into electrical contact with said first or second wiring layer.

3. A variable capacitor system according to claim 1, wherein
said variable capacitor and said fixed capacitors are formed electrically in parallel, total capacitance of said fixed capacitors is larger than maximum capacitance of said variable capacitor, and said switch controls the number of said fixed capacitors connected electrically.

4. A variable capacitor system according to claim 1, wherein
an interval of total fixed capacitance varied when total capacitance of said fixed capacitors connected to a circuit electrically by said switch is varied is smaller than a variable capacitance range of said variable capacitor.

5. A variable capacitor system according to claim 1, wherein
an interval of total fixed capacitance varied when total capacitance of said fixed capacitors connected to a circuit electrically by said switch is varied is larger than a variable capacitance range of said variable capacitor.

6. A microswitch comprising:
a substrate;
first and second wiring layers formed on said substrate with space therebetween;
a beam supported to said substrate and having a conductive junction;
a driving mechanism for bring said junction into electrical contact with said first or second wiring layer; and
a temperature control mechanism for controlling temperature of said beam.

7. A microswitch according to claim 6, wherein
said beam is formed to be deformed by said driving mechanism so that said junction is brought into electrical contact with said first or second wiring layer, and said temperature control mechanism is formed on a back side of a surface of said substrate in which said beam is formed.

8. A transmitter-receiver comprising:
a plurality of antennas;
an antenna changing-over switch for changing over said antenna;
an amplifier supplied with a signal received by said antenna through said antenna changing-over switch;
a control IC supplied with a signal produced by said amplifier and for producing an output signal; and
a temperature control mechanism for controlling temperature of said antenna changing-over switch;
said antenna changing-over switch including:
a substrate;
first and second wiring layers formed on said substrate with space therebetween; and
a beam supported to said substrate and having an electrode brought into electrical contact with said first or second wiring layer.

9. A transmitter-receiver according to claim 8, wherein
said beam is formed movably so as to bring said electrode into electrical contact; and
an insulating layer is formed between said substrate and said first or second wiring layer;
a layer constituting said temperature control mechanism being formed between said substrate and said insulating layer.

10. A transmitter-receiver according to claim 8, wherein
said temperature control mechanism is disposed on an opposite side of a surface of said substrate on which said beam is formed.

11. A receiver comprising:
a plurality of antennas provided in corresponding manner to frequencies;
an antenna switch for switching electrical connection to said antennas;
a filter for removing noise from a signal supplied from said antenna through said antenna switch;
an amplifier for amplifying a signal passing through said filter; and
a control IC supplied with a signal produced by said amplifier and for producing an output signal;
said antenna switch and said filter being disposed in a first substrate, said control IC being disposed in a second substrate.

12. A receiver according to claim 11, comprising a temperature control mechanism disposed in said first substrate.

13. A transmitter-receiver comprising:
a plurality of antennas provided in corresponding manner to frequencies;
an antenna switch for switching electrical connection to said antennas;
a filter for removing noise from a signal supplied from said antenna through said antenna switch;
an amplifier for amplifying a signal passing through said filter;
a control IC supplied with a signal produced by said amplifier and for producing an output signal; and
a heat transportation mechanism for transporting heat generated by said control IC to said antenna switch or said filter.

14. A transmitter-receiver comprising:
a plurality of antennas provided in corresponding manner to frequencies;
an antenna switch for switching electrical connection to said antennas;
a filter for removing noise from a signal supplied from said antenna through said antenna switch;
an amplifier for amplifying a signal passing through said filter;
a control IC supplied with a signal produced by said amplifier and for producing an output signal; and
a radiation veer disposed in said substrate in which said control IC is formed.

15. A transmitter-receiver comprising:
a plurality of antennas provided in corresponding manner to frequencies;
an antenna switch for switching electrical connection to said antennas;
a filter for removing noise from a signal supplied from said antenna through said antenna switch;
an amplifier for amplifying a signal passing through said filter; and
a control IC supplied with a signal produced by said amplifier and for producing an output signal;
a thermoelectric element disposed in a substrate in which said control IC is formed.
